(19) United States
(12) Patent Application Publication
(10) Pub. No.: US 2018/0345280 A1
(43) Pub. Date: Dec. 6, 2018

(54) APPARATUS FOR INDUCING MICROFLUIDIC FLOW

(71) Applicant: MIMETAS B.V., Leiden (NL)

(72) Inventors: Paul VULTO, Leiden (NL); Sebastiaan Johannes TRIETSCH, Leiden (NL); Arnaud Yannick Michel NICOLAS, Leiden (NL)

(73) Assignee: MIMETAS B.V., Leiden (NL)

(21) Appl. No.: 15/778,848

(22) PCT Filed: Nov. 28, 2016
(86) PCT No.: PCT/NL2016/050835

§ 371 Date: May 24, 2018

(30) Foreign Application Priority Data
Nov. 26, 2015 (NL) NL2015854

(51) Int. Cl. B01L 3/00; B01L 9/00

(52) U.S. Cl. CPC B01L 3/50273; B01L 9/527; B01L 3/502715; B01L 2200/025; B01L 2200/027; B01L 2400/0457; B01L 2300/168; B01L 2300/18; B01L 2200/06; B01L 2300/0816

(57) ABSTRACT

The invention relates to an apparatus for inducing flow of a fluid in a microfluidic device that comprises at least one microfluidic channel, the apparatus comprising: a base, on which said microfluidic device is pivotally disposed, defining a first position in a first plane (I); and a selectively operable tilting element attached to said base, to pivot the microfluidic device with respect to the base, thereby inducing fluid flow through the at least one microfluidic channel; wherein the base accommodates the microfluidic device in a first position defining a first plane, wherein the tilting element pivots the microfluidic device from the first position to a second position defining a second plane (II), and wherein the microfluidic device is tilted about a pivoting axis bisecting the first plane, thereby defining an inclination angle α between the first plane and second plane.

The present invention relates to a method, and an apparatus for inducing a fluid flow in a microfluidic apparatus based on reciprocal leveling between two reservoirs.

Induction of a fluid flow is a particularly generic aspect of microfluidic devices. Particularly in the case of cell culture, fluid flows are thought to be important to mimic a physiologically relevant situation, similar to flow of blood, or other body fluids. In microfluidic devices, fluid flow is typically induced by pumping making use of active pumps, including peristaltic pumps and syringe pumps.

Alternatively, leveling between two fluid reservoirs of which the liquid level in one reservoir is higher than that of the other, is a particularly versatile way of pumping fluid. If the two reservoirs are connected by means of a microfluidic channel, the leveling between two reservoirs results in a flow through the channel. The reason for this is that this so-called passive leveling does not need any complicated external equipment.

A disadvantage of this latter technique is however that over time liquid levels equilibrate such that either the time span over which perfusion flow can be maintained is shorter, very large hydraulic resistances of the microfluidic channels are needed or extremely large liquid volumes are needed to maintain flow in a microfluidic device.

An approach of solving this problem is to place a microfluidic device on a laboratory rocker platform or table, whereby the microfluidic device is tilted to an angle on the rocker platform by movement of the latter, such that leveling takes place between the higher reservoir and the lower reservoir.

At a given time-interval the angle of the rocker platform is reversed, such that the other reservoir is now higher and leveling occurs in the opposite direction and the fluid flow in the device is reversed. In this manner, a fluid flow can be maintained indefinitely or for as long as the experiment lasts.

The principle of inducing flow in a microfluidic device by the use of a laboratory rocker is disclosed for instance in U.S. Pat. No. 8,748,180. Herein, a microfluidic device is subjected to a reciprocating motion, such that a fluid medium is flowing between a pair of connected reservoirs, thereby effecting a gravity-induced flow in the microfluidic channels.

A disadvantage of the use of general laboratory shaker or rockers for maintaining flow in a microfluidic device is the fact that these devices are unnecessary bulky. This is primarily due to the fact that these laboratory rockers are not designed for inducing fluid flow in microfluidic channels, but rather to agitate fluid in cell culture flasks or petri dishes. Typical laboratory shakers or rockers are devices that comprise a platform which are subjected to a rocking and/or shaking motion, generally performing an oscillating movement around a central axis that induces a flow of fluids in the vessels. Examples of such laboratory shakers are disclosed in for example US-A-20100159600, WO2013017283, US-A-2011014689, US-A-2010304474 and GB-A-2451491. The minimal height of these rocker platforms are defined by the length of the platform in a direction orthogonal to the rotational axis and the maximum angle of rotation. In addition, the driving mechanism or actuator of the rocking movement is typically positioned underneath the platforms, thus making the rockers even higher. For example, US-A-20100159600 describes a rocker which tilts a microfluidic device in opposite directions about pivot axes which are located at the bottom of its platform, are on opposite sides of the microfluidic device and are several centimeters beneath the microfluidic device.

The disadvantages of using a bulky laboratory rocker for inducing flow in microfluidic devices can be summed up as follows: the rocker occupies quite substantial volume in incubators, which limits the number of experiments/cell cultures that can be run in a single incubator; the rocking motion of such a platform does not permit real-time optical, e.g. microscopic observation, as there is no access from the underside for an objective and the horizontal position of the device is poorly defined, unless the microscope is affixed to the rocker platform as well, which is highly impractical; the use of a laboratory rocker is difficult, if not impossible to combine with so-called plate hotels in which a large quantity of multi well micro titer plates are placed in a regular fashion such that they are individually accessible for robotic manipulation.

Furthermore, in microfluidic applications such as cell incubation, it is typically required to subject the samples to climate conditions as required, e.g. incubation at an elevated temperature, under humidified conditions and/or with determined and adjusted oxygen or carbon dioxide levels.

The present invention now allows subjecting single, but also a multitude of microfluidic devices to a standardized movement, and permits incubation under desired conditions.

### SUMMARY OF THE INVENTION

Accordingly, the present invention relates to an apparatus for inducing flow of a fluid in a microfluidic device that comprises at least one microfluidic channel, the apparatus comprising:
a. a base, on which said microfluidic device is pivotally disposed, defining a first position in a first plane (I); and
b. a selectively operable tilting element attached to said base, to pivot the microfluidic device with respect to the base, thereby inducing fluid flow through the at least one microfluidic channel.

Advantageously, the base accommodates the microfluidic device in a first position defining a first plane, wherein the tilting element pivots the microfluidic device from the first position to a second position defining a second plane (II), and wherein the microfluidic device is tilted about a pivoting axis bisecting the first plane, thereby defining an inclination angle α between the first plane and second plane.

In a second aspect, the present invention also relates to an arrangement comprising a multitude of the apparatuses.

In a third aspect, the present invention also relates to a method for providing fluid flow to one or more microfluidic devices.

In yet another aspect, the present invention also pertains to subjecting the microfluidic device to an analysis.

Further aspects are set out in detail below.

### BRIEF DESCRIPTION OF THE DRAWINGS

The present invention is described herein with reference to the accompanying drawings, in which similar reference characters denote similar elements throughout the several views. It is to be understood that in some instances, various aspects of the invention may be shown exaggerated or enlarged to facilitate an understanding of the invention.

FIG. 1 depicts a top view of a first preferred embodiment of the apparatus according to the invention comprising a base provided as a plate 101, an end stop 102 and a tilting element 103.

FIG. 2 depicts a side view of the apparatus of FIG. 1.

FIG. 3 depicts a side view of the apparatus of FIGS. 1 and 2, including a microfluidic plate 301 in a first (I), horizontal resting position.

FIG. 4 depicts in side view of the apparatus of FIGS. 1 to 3, whereby the microfluidic plate has been moved into a second tilted position (II) and whereby the inclination angle α between the first and second plane is depicted.

FIG. 5 depicts in top view a second preferable embodiment of the apparatus according to the invention, the apparatus comprising a base plate 101, a tilting element 103, a tilting frame 501 and a hinge 502.

FIG. 6 depicts in side view the apparatus of FIG. 5.

FIG. 7 depicts in side view the apparatus of FIG. 5 including a microfluidic plate in a resting position.

FIG. 8 depicts in side view of the apparatus of FIG. 5 including a microfluidic plate in a tilted position

FIG. 9 depicts a top view of a second preferable embodiment of the apparatus according to the invention, showing an apparatus comprising a frame 101 having an opening 901, further comprising an ocular, positioned such that the microfluidic plate can be observed from the underside.

FIG. 10 depicts a side view of the apparatus of FIG. 9.

FIG. 11 depicts a side view of the apparatus of FIGS. 9 and 10, including a microfluidic plate in a resting position

FIG. 12 depicts a subunit of an exemplary embodiment of a microfluidic apparatus in vertical cross-section, wherein the microfluidic apparatus consists of a single microfluidic channel 1202 that has two reservoirs 1201 that may contain liquid. A third reservoir 1203 may provide optical access to the microfluidic channel for illustration.

FIG. 13 depicts a subunit of the microfluidic apparatus of FIG. 12 in top view.

FIG. 14 depicts the microfluidic apparatus of FIG. 12 in cross section under inclination and filled with liquid. The liquid level in the upper reservoir is higher than in the lower reservoir, resulting in a fluid flow

FIG. 15 depicts the apparatus of FIG. 14 under inclination, whereby the liquid levels in both reservoirs are the same.

FIG. 16 depicts the apparatus of FIG. 14 in horizontal position, whereby the liquid level in the right reservoir is higher than the liquid level in the left reservoir.

FIG. 17 depicts the apparatus of FIG. 14 in horizontal position, whereby the liquid level in the right reservoir and the left reservoir are the same.

FIG. 18 depicts in top view a multitude of structures such as shown in FIG. 13 organized in a microtiter plate.

FIG. 19 depicts the structure of FIG. 18 in vertical cross-section.

FIG. 20 schematically depicts an embodiment of the apparatus of invention with in-use the apparatus of FIG. 18.

FIG. 21 depicts another preferred embodiment of the apparatus of invention, comprising a multitude of apparatuses for inducing flow.

FIGS. 22 to 25 depict a preferred embodiment of the present invention or aspects thereof:

FIG. 22 depicts the apparatus comprising a microfluidic device with the proportion of a microtiter plate titer plate in a three-dimensional side view also showing an exemplary tilting element having a lever 2201 driving a geared actuator 2002 that acts as lifting element;

FIG. 23 represents a top-view of the device with a microfluidic device, whereas

FIG. 24 shows the device without the microfluidic device, and

FIG. 25 shows an enlarged detail of the device of FIG. 24, namely the base plate 101 and an end-stop 102 executed as a raised edge configured and shaped to accommodate the microfluidic device.

The device according to the invention is intended for inducing flow in a microfluidic channel by leveling of liquid levels between two communicating reservoirs. The reservoirs communicate through the microfluidic channel, thus inducing a flow through that channel. The apparatus thus operates by tilting a microfluidic plate that comprises at least a microfluidic channel that connects two reservoirs. When the reservoirs are filled with equal liquid volumes, tilting of the device into a titled, second state results in the liquid level in the higher reservoir being higher than the liquid level in the lower reservoir. The two reservoirs are leveled through the microfluidic channel, effectively resulting in a flow through the channel. Once leveled, the total liquid volume in the lower reservoir is higher than the total volume in the upper reservoir. Bringing the device now into a first, e.g. horizontal position, thus into a first state, the liquid level in the reservoir with higher liquid volume will be higher than that of the other reservoir and leveling occurs in opposite direction, yielding an effective flow in reverse direction with respect to the flow under inclination.

The one or more reservoir may be a separate reservoir, i.e. a space provided in fluid connection with the microfluidic channel, or it may form part of the microfluidic channel. The flow through the channel is maintained by bringing a microfluidic device in such a state, either horizontal or tilted, such that the liquid levels in two communicating reservoirs are different. The apparatus according to the invention in its simplest form hence is a binary device that facilitates two states: a first, preferably horizontal state as defined by the base, and an inclined state as defined by the height of the lifting motion imposed by the tilting element and/or the position of an end-stop. The transition between the two states occurs in a discrete manner, and the interval can be adjusted according to flow requirements. Yet further, since the movement and tilting element only have to induce a single-sided movement, they are much simpler in construction than conventional rocker shakers. Whereas a conventional rocker translates a platform in up and downward direction typically in a continuous manner, the apparatus according to the invention changes between inclined and first, preferably horizontal state in a discrete manner.

The apparatus according to the invention may advantageously have the at least the following three different functions: as a microscope compatible flow generation platform by upside out-of-plane rocking; as a device to be placed in an incubator, which inherently takes less vertical space; and as a modification to a conventional “plate hotel”, such that plates can be perfused inside the “hotel”, i.e. an incubated space holding a multitude of microfluidic devices.

The induction of flow according to the method of invention is thus preferably a binary process in which the microfluidic device is either under an inclination or in its base position. Since the base positions may already be in in an inclination, the difference between the two angles leads to the induction of the flow. However, in a preferred and simplest form, the base position is an essentially horizontal position of the base position. The time frame within which the two states are assumed can be varied and is typically in the range of seconds, minutes, tens of minutes, hours and even a day. The flow in the channel is a resultant of the pressure difference and the hydraulic resistance of the channel. The pressure difference is a resultant of the difference in fluid levels. Since fluid levels out with time, the flow dampens out with time as well. Tuning the time interval between two states allows to increase the mean normalized flow rate and reduce the variation thereof. Flow of a fluid, e.g. a liquid growth medium, enables to provide a constant environment in terms of oxygen distribution, metabolite concentration, as well as exposure to compounds and delivery of compounds, the effect of which on the cells is to be assessed.

The subject apparatus comprises a base, on which said microfluidic device is pivotally disposed. It further comprises a selectively operable tilting element to pivot the microfluidic device on the base, thereby inducing fluid flow through the microfluidic channel.

The rotation axis over which the microfluidic device may be pivoted, further referred to herein as pivoting axis, is preferably defined by the intersection of a first and second, or further positions, i.e. resting and tilted position(s) of the microfluidic device.

The pivoting axis is advantageously based either at a first end of the base in the horizontal plane defining the base, or between a first end of the microfluidic device and the geometric center, or center of gravity, of the microfluidic device.

The orientation of the pivoting axis relative to the base and/or microfluidic device may be advantageously chosen in line with the volume of work space available to tilt the microfluidic device. For some embodiments, the volume of work space available for the tilting action may dictate the design of the pivoting mechanism. A position of the pivoting axis essentially in the horizontal plane, thus bisecting the plane may advantageously be chosen such that it allows to tilt the microfluidic device from the substantially horizontal first plane to any selected tilting angle without negatively affecting any measurements that may be performed on the microfluidic device.

This is the case for instance when the pivoting axis intersects the microfluidic device, whereby a portion of the microfluidic device may protrude under the base when the microfluidic device is inclined. For example, if the pivoting axis would traverse the geometric center of the microfluidic device, the volume of space required to achieve the desired tilting is minimized.

As set out above, the pivoting axis bisects the first plane. The term “bisects” herein refers to the line defining the axis formed by the pivot points that is contained within, or essentially is contained within the first plane.

The term “within”, or “essentially within” refers to the pivoting axis being directly contained in the plane that is defined by the first, preferably horizontal resting position, by the underside of the microfluidic device.

“Essentially within the plane” herein includes variations wherein the pivoting axis may be slight above or below this plane, e.g. in a plane between the planes defined by the upper side and the underside of the microfluidic device; or slightly below, i.e. offset by a very short distance above or below the planes set out above in case of e.g. a frame taking up the microfluidic device, which then is tilted directly or through a hinge. A typical distance for the position of the pivoting axis is however less than 1 centimeter distance to the base, more preferably less than 1 millimeter, i.e. preferably in a range of from 1 mm to 1 cm above or below the first plane.

The fact that any pivoting axis in the apparatus according to the invention lies essentially within the plane is quite different from those of typical laboratory rockers, whereby a platform pivots around an axis typically well below the platform.

Preferably, the pivoting axis is horizontally distanced from the lifting point of the microfluidic device by a distance of at least half of length L.

The pivoting axis according to the apparatus of invention is preferably positioned largely in the first, preferably horizontal, plane or in direct vicinity thereof, as a direct consequence of the position of the end-stop and/or hinge.

This allows a relatively flat construction of the device making it ideally suited to optimally make use of limited space in for instance cell culture incubators.

The upward translation requires a relatively simple actuation mechanism making the apparatus of invention particularly suitable for integration on a microscope platform or for incorporation in a plate hotel.

The apparatus according to the present invention is preferably configured to receive and securely hold the microfluidic device, also during the tilting action. The base defines a first surface defining generally a first plane, upon which the microfluidic device may be disposed. The first plane may be horizontal, or at an angle from the horizontal position. The inclination or tilting angle α is then defined by the difference between the position of the first plane and a second plane defined by the base in tilted position. As the tilting element, or a lifting element comprised in the tilting element moves, the microfluidic device is rotated about the pivoting axis that essentially intersects the first and second plane. This rotation tilts the microfluidic device placed in the base until the inclination angle α is attained.

The present invention relates to an apparatus for generating fluid flow in a microfluidic channel in a microfluidic device by pivoting or tilting the device. The apparatus thus further comprises a tilting element for preferably reversibly vertically pivoting the microfluidic device thereby tilting the device over a pivoting axis. As set out above, the pivot axis essentially is contained within the first plane. When the device is tilted from the first position to a second position at a different inclination, the latter defines a second plane. The two planes are thus at an inclination angle α between the first and the second plane as measured over the pivot point defining the pivoting axis. Hence, the pivoting axis is contained within lies within, or essentially lies within the first plane.

The apparatus according to the invention comprises (b) a selectively operable tilting element to pivot the microfluidic device on the base, inducing fluid flow through the microfluidic channel.

The tilting element preferably comprises a lifting element. The lifting element is preferably configured to vertically lift the apparatus, and/or the microfluidic device by application of force or otherwise, provided the lifting motion is achieved.

Any suitable lifting mechanism may be employed in the lifting element to achieve the tilting motion of the apparatus. Where applicable, the point at which pressure is applied onto the base or the microfluidic device by the lifting element is referred to as the “lifting point” herein.

The lifting point preferably is placed opposite to the pivot axis, more preferably towards the opposite end vis-à-vis the pivot axis of the centre of gravity of the microfluidic device. Where a symmetrical microfluidic device is employed, the centre of gravity of the plate is the halfway of the one of the two main axis of the microfluidic device. The term “centre of gravity” herein refers to the point attributed to the centre of mass of a microfluidic device.

In case that a linear lifting mechanism is employed, the lifting is performed by exerting force onto an initial lifting point. This initial point is the lifting point referred to in the below spatial definitions. During the lifting motion, however, the lifting point may move along the base of the microfluidic device, e.g. the linear lifting element, such as a pin, mentioned above. This shifting motion of the lifting point is even more pronounced in the case that e.g. an eccentric wheel mechanism is employed, as the lifting point then shifts over the surface of the microfluidic panel or apparatus during the lifting, effectively oscillating between two end points. Depending on the actual lifting element, also, a lifting axis or lifting area may apply rather than a single lifting point. In this case, the point closest to the centre of gravity is employed to calculate the distance.

When the microfluidic device is tilted, a lateral force due to the gravity of the device is exerted onto the base, which may result in a lateral movement of the microfluidic device, by shifting or slipping on the base. Since this motion is not desirable, in the apparatus according to the invention, the lateral movement of the microfluidic device is limited by geometrical elements, such as an end stop, or by making use of material properties, such as a coating of a high friction material. Preferably, an end stop is used. The end stop is disposed to limit lateral or downward shifting motion of the microfluidic device when tilted. By “shifting motion”, a shifting of the microfluidic device in the first plane is referred to herein.

The end stop may be any suitable element that impedes this shifting motion. Advantageously, it may be a protruding or recessed element that limits travel by physical contact, such as a ridge, or it may comprise material that limits travel due to high friction applied. In a further, preferred alternative that is set out below, the microfluidic device may also be secured in a frame also comprising the end stop.

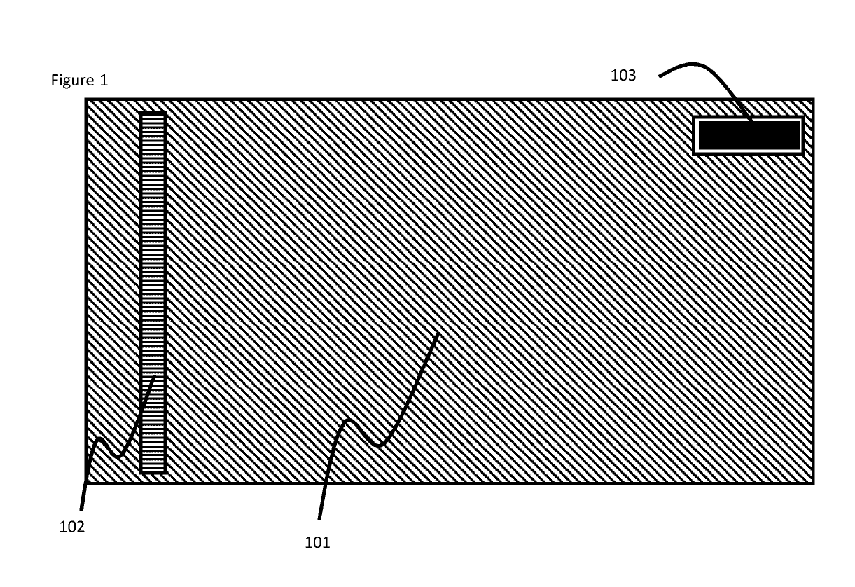

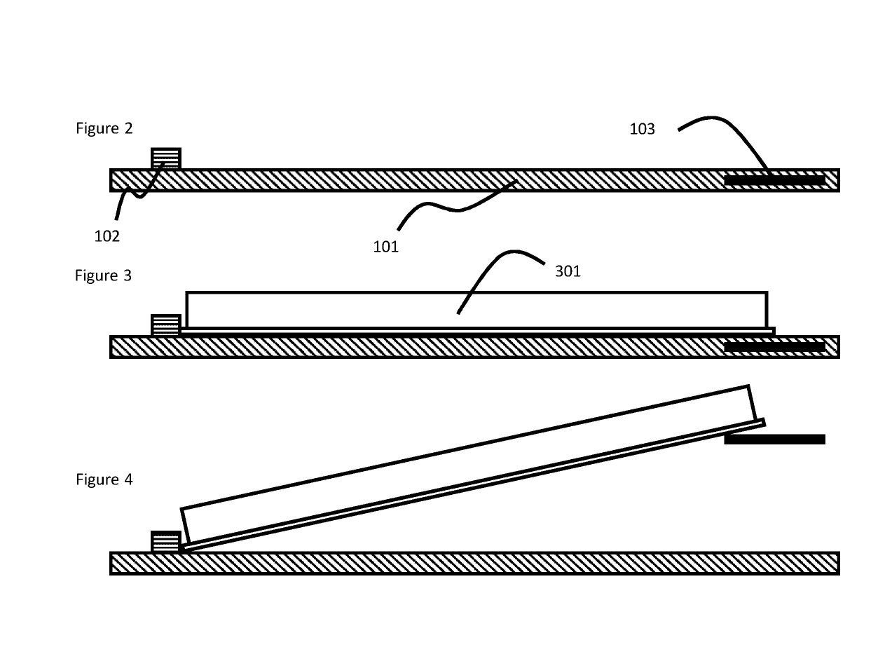

In FIG. 1, the apparatus of invention in a first preferable embodiment comprises a base plate 101, an end stop 102 and a tilting element 103, which is sketched herein schematically as an impression, and does not represents a fully working embodiment. A person skilled in the art would be well aware that any type of tilting element scan be used according to the invention.

In FIG. 3, the microfluidic plate 301 is positioned on the baseplate against the end stop. The microfluidic plate is lifted (FIG. 4) on one side such that it pertains an inclination to the base plate. The microfluidic plate is lifted from a first position in a first plane (I) to a second position in a second plate (II), over an inclination angle α. The vertical position is determined by the end stop that prevents the microfluidic plate from possible shifting in lateral direction.

The apparatus further may comprise an element that pushes the plate towards the end stop. Preferably this element is the same as the tilting element.

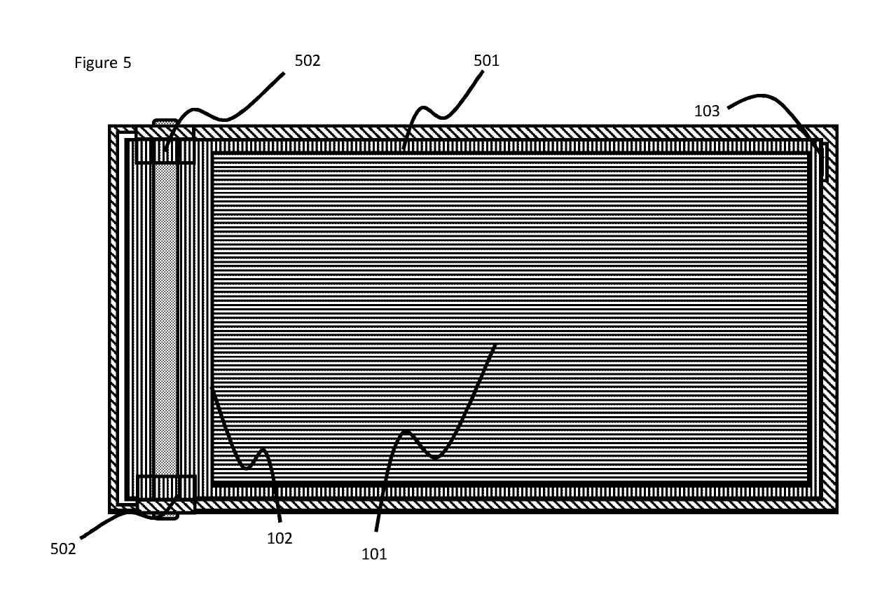

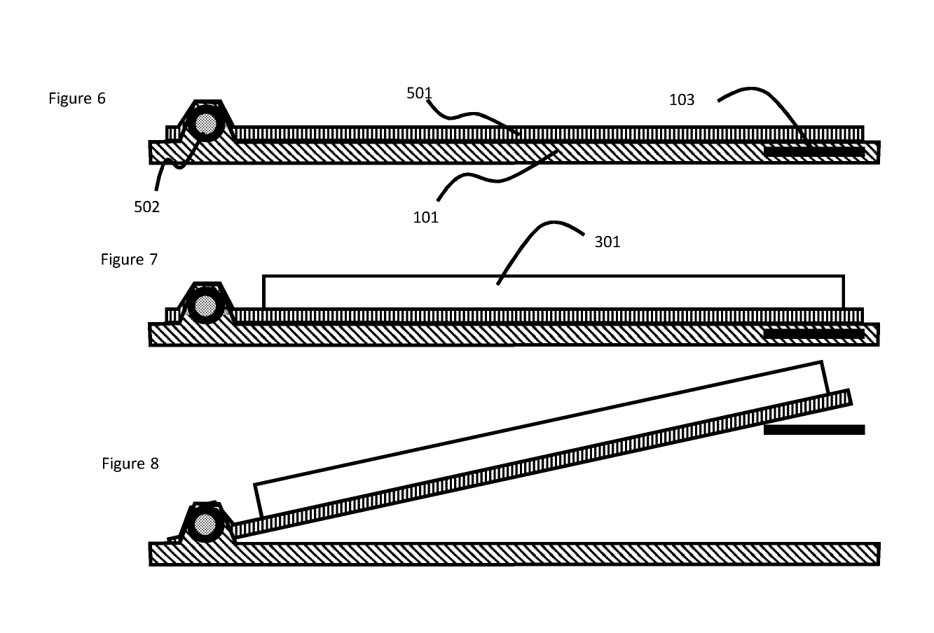

The apparatus may further comprise a sensor to determine the position of the tilting element. In a second preferable embodiment in FIG. 5, the apparatus is comprised of a base plate 101, a tilting element 103, a tilting frame 501 and a hinge 502. The end stop is placed on the tilting frame that prevents shifting of the plate in downward and lateral direction.

The flow rate in the microfluidic device is dependent on the difference in height between the two liquid levels as well as the hydraulic resistance of the microfluidic channel. The difference in liquid level can be maximized by increasing the angle of inclination, as well as by optimizing the interval between horizontal and tilted state. The larger the hydraulic resistance, the slower the flow rate and the longer a flow can be maintained in a given state.

Fluid medium present in the microfluidic device is brought into motion through tilting. The thus induced flow is generated through leveling of reservoirs in which the liquid level in one reservoir is higher than in the other, thereby generating a fluid flow from the higher liquid level to the lower liquid level, which is further referred to as gravity induced flow.

Preferably, the one or more pivoting axis is or are separated from the centre of gravity of the microfluidic device by a distance Lₚ, and L_{p′}, or Wₚ and W_{p′} respectively. Lₚ and L_{p′} respectively, refer to the distance between the centre of gravity of a microfluidic device, and the relevant length axis over which the device is pivoted, whereas Wₚ and W_{p′} respectively, refer to the distance between the centre of gravity of a microfluidic device along the Width of the microfluidic device if the pivot axis runs orthogonally to the major Length axis of the device.

In a preferred embodiment, the two pivoting axis are arranged essentially orthogonal to each other, and are both bisecting the first plane.

Microfluidic devices for use with the present invention are preferably shaped and formatted such that they have a standardized size and shape, e.g. those of a conventional multi-well plate, also referred to as a micro titer plate. This is advantageous, as it permits to use equipment that is used for micro titer plates, including equipment for handling such as robots or pipettes, for incubating and/or read-out such as microscopes, plate readers, and/or high content readers.

In the example of a microfluidic device proportioned as a microtiter plate, a typical configuration of the present invention would be to tilt the plate on one side of its longitudinal axis, while holding the plate on the other side by an end-stop. In a preferred embodiment, the tilting element may exert a force towards the end stop in order to assure a precise position, once returning to its horizontal state. In another preferred embodiment, a separate device may exert a force on the microfluidic device to the same avail.

In a further embodiment according to the invention a further tilting element for reversibly tilting the device is provided. The tilting element may be used to tilt an in-use microfluidic device in a second direction. This may be on the opposite site with respect to the first tilting element. In this manner, the microfluidic device is tilted in two directions along the longitudinal axis. This could potentially lead to higher flow rates in a microfluidic channel. In another example, the second tilting element could be placed on the lateral axis with respect to the first tilting element. In this manner, reservoir leveling can be controlled between more than two reservoirs yielding an extended flow control.

In the second example in which the second tilting element is placed at one end of the lateral axis of the microfluidic device, the microfluidic device is tilted from the horizontal position to an inclined position in a second plane over an inclination angle β to the horizontal plane over a second pivoting axis. The second pivoting axis may be perpendicular or beveled at a suitable angle to the first pivoting axis. Preferably, the second pivoting axis is essentially perpendicular to the first pivoting axis. US-A-20100159600 discloses a second pivoting axis, however this second axis is not essentially bisecting the first plane (which, incidentally, the first axis also is not), nor is at an angle to the first pivot axis, amounting to a simple variation of a central pivoting axis as in most other rockers, and not providing the benefits.

Preferably, separately or simultaneously, the rotation over the first pivoting axis tilts the microfluidic device placed in the base through the first tilt or inclination angle α, while also rotating the microfluidic device through a second tilt or inclination angle β about a second pivoting axis. The base design and shape advantageously determines the two tilting and rotation motions and the tilt angles.

Advantageously, the second pivoting axis is distanced from the centre of gravity of the microfluidic device by a distance W_{p′}. More preferably, the second pivoting axis is distanced from the second lifting point by a distance of more than half the width W.

Advantageously, in a further embodiment the first and second pivoting axis are distanced from the center of gravity of the microfluidic device by a distance Lₚ, or L_{p′}, and Wₚ and W_{p′}, respectively. In yet a further preferred embodiment, the first and second pivoting axis are spaced apart by a distance L_{p″}, or L_{p′″}, respectively, defined by the centre of gravity of microfluidic device plus the distance to the pivot axis running though the centre of the hinge of a hinged frame that extends beyond the microfluidic device, whereby the relevant pivoting axis intersects the respective hinge.

Preferably, the first pivoting axis is located opposite the lifting point with respect to the centre of gravity of the microfluidic device. More preferably, the pivoting axis is spaced from the lifting point at which the lifting element is lifting the microfluidic device, by a distance of at least half of length L of the major axis of the microfluidic device, and/or width W if a second axis of the lifting element is positioned orthogonal to the major axis of the microfluidic device.

Yet more preferably, the end stop is co-located with the pivoting axis, and wherein the lifting point is located at the opposite side of the end stop, respectively, with respect to the centre of gravity of the microfluidic device.

Any distance that is suitable for ensuring an appropriate inclination angle may be employed. However, preferably, the distance preferably is at least half of L, or W, respectively.

The lifting point herein refers to the point where the tilting element exerts an upward force on one side of the microfluidic device, or the hinging platform. By “distance”, the shortest distance between the lifting point and the pivoting axis is implied.

Advantageously, the pivoting axis is provided by an end stop limiting lateral, or downward shifting movement of the microfluidic device during tilting; or a hinge configured to rotatably and securely accommodate the microfluidic device, such that no such lateral travel is allowed.

Preferably, also in such case, both the first and second pivoting axis lie essentially inside the first plane defined by the underside of the microfluidic device.

The microfluidic device comprises at least one microfluidic channel. This channel typically has a bottom surface and side walls, and is closed off by a top substrate, whereby a fluid medium present in the device typically wets all four channel surfaces. The channel cross section may be any shape, but preferably is square or trapezoid. Alternatively, the channel may have a cross sectional shape of a half circle, elliptic, rectangle and/or trapezoid with rounded corners. Suitable devices are for instance disclosed in PCT/NL2015/050416, US-A-20150238952, US-A-20140065597, EP-A-2683811 or EP-A-2683481.

In either case, the apparatus induces flow, while repositioning the microfluidic device and/or the frame reproducibly into the resting or starting position, thereby resulting not only in a flow in the microfluidic channel, but equally enables to measure parameters in the micro channels by instruments that require an identical position for measurements to be taken, e.g. optical microscopes and other suitable imaging devices.

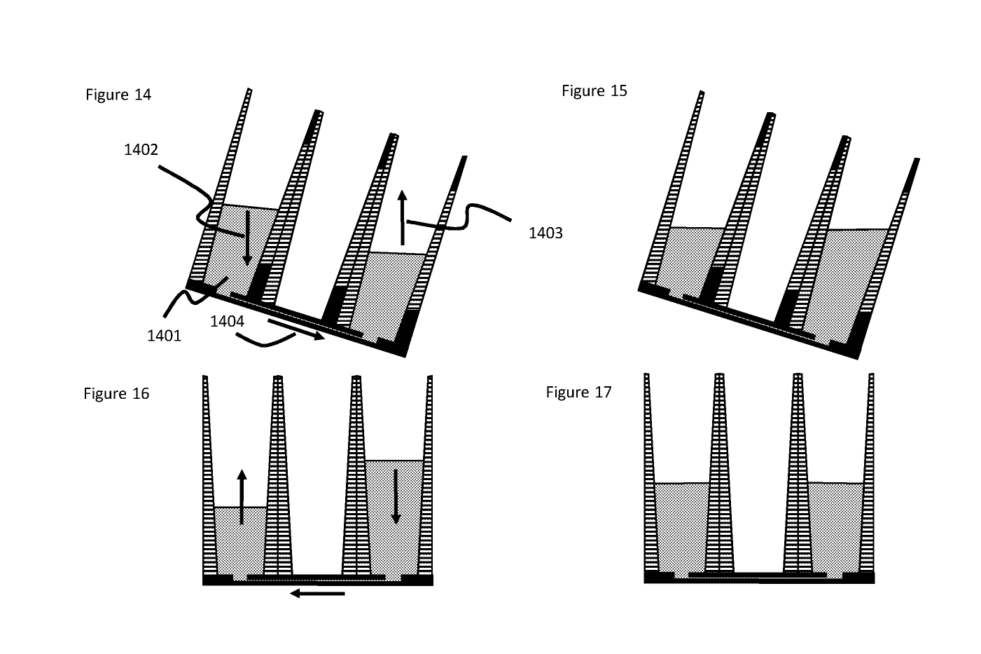

The method according to the invention is illustrated in FIG. 14. In the microfluidic apparatus of FIG. 14, the liquid level in the upper reservoir is higher than in the lower reservoir, resulting in a fluid flow. Generally, when liquid reservoirs are filled with equal volumes of liquid and the apparatus is placed under an inclination, the liquid levels between the higher reservoir and the lower reservoir results in liquid flowing from the higher reservoir to the lower reservoir through the microfluidic channel, effectively resulting in a flow through the microfluidic channel. This flow will stop once the fluid is leveled out. However, the volumes in the reservoirs upon leveling under inclination have changed, yielding a higher volume in the downstream reservoir, i.e. the right-hand side reservoir 1403 depicted in FIG. 14. In a next step according to the method, the microfluidic apparatus is brought back in its horizontal position. Now, the liquid level in the right reservoir is higher than the liquid level in the left reservoir and leveling occurs in opposite direction, generating a fluid flow in the microfluidic channel in reverse direction. Once leveled out, the flow can be reversed again by tilting the apparatus on one side and inducing an inclination. The steps depicted by FIGS. 15 and 17 are solely for illustration purpose, and do not necessarily need to be part of the method according to the invention; in fact, the flow can be reversed already prior to complete leveling between the reservoirs.

In a simple, yet elegant first advantageous embodiment of the present invention, the apparatus comprises at least one end stop that limits the movement of the microfluidic device horizontally and laterally, such that the device can be placed in a first horizontal starting or resting position; and a tilting element that may be driven by an actuator. The tilting element is configured to tilt the microfluidic device over the pivoting axis.

The end stop preferably holds the plate in place when it is moved out of the horizontal plane by the tilting element such that, once the platform is at an angle from the horizontal position, it does not shift laterally.

Preferably, the device is configured to comprise a single microfluidic device. However, a multitude of the device may be employed to accommodate a multitude of microfluidic devices, whereby each microfluidic device is subjected to an identical motion over the same axis.

The tilting element preferably moves the microfluidic device such that the vertical translation with respect to the horizontal plane is upwards over essentially all, or at least a majority of the microfluidic device. This may advantageously be achieved by rotation over an axis outside, at the corner, or at least offset from the center of the microfluidic device. The thus induced movement differs strongly from the movement of plates that are placed on a conventional laboratory rocker, since those will move out from the horizontal plane in both down- and upwards direction, while in the case of the invention the translation occurs in upwards direction primarily. Preferably, the tilting element comprises a lifting element arranged and configured for lifting the microfluidic device on one side.

The lifting element may be driven or actuated by a mechanical, electrical, hydraulic and/or magnetic drive or actuator. Any drive or moving element suitable to ensure appropriate movement of the microfluidic device may be employed.

The lifting element may for instance comprise a wheel that is eccentrically connected to a stepper motor or otherwise rotating actuator. Otherwise the actuator may rotate a wheel that has a pin placed eccentrically that acts as tilting element. The lifting element may also be actuated by a linear actuator that pushes a pin or plateau upwards. In some cases, the actuator itself may be the tilting element. The lifting element may also be driven over a rail or recess, by a linear or other suitable type of actuator. In the case of a hinged platform, the tilting element may be an actuator that is affixed at a suitable position of the platform or the frame comprising the platform. In a preferred, simple form, the actuator may represent the tilting element, or the lifting element.

Preferably, the end point and time interval between tilted and first, preferably horizontal state are adjustable. More preferably the tilting element may be provided with an adjustable amplitude. Yet further, preferably the time, speed and duration of the inclination is adjustable. Preferably, the actuator of the tilting and/or lifting element or the tilting or lifting element itself is monitored by a sensor that detects information about the position of the tilting element, which can be used for calibration or adjustment of the tilting level and/or angle.

The tilting element may thus suitably comprise an electric drive, and a lifting element that exerts force or pressure onto the microfluidic device, and/or the base holding the device. Other forms of subjecting the plate or device to the tilting motion may principally also be used. These may advantageously comprise unbalance exciters, hydraulic drives or magnetic drives.

The structure of the apparatus inherently and fully automatically returns the microfluidic device to the first position, such that when used in automated laboratories the microfluidic device is reliably returned to the starting position, thereby allowing a defined access by a robot, e.g. feeding or removing by means of robot grippers.

Yet further, advantageously this will also allow optical or otherwise measurement of the substrate in the microfluidic channels, since their position is identical after each tilting movement. Advantageously, the subject device, arrangement comprising one or more devices, and methods may also be applied to standard microtiter plates with normal wells, whereby agitation of fluids can be ensured under incubation and monitoring conditions.

In a particular embodiment, the apparatus preferably comprises an open frame of suitable, preferably rectangular shape, having two parallel sides joined by two ends perpendicular thereto, the internal dimensions of the frame being adapted to accommodate a microfluidic device of essentially rectangular shape of preselected size nested within the frame; preferably of the dimensions and shape, or at least the footprint of a standardized micro titer plate.

In a further preferred embodiment according to the invention the base may comprise a hinged platform or frame configured for receiving the microfluidic device, the frame further comprising a tilting mechanism. In yet a further preferred embodiment this hinged platform also comprises an end-stop, either for receiving the hinged frame, or built into the frame in a different manner.

The frame preferably comprises a bottom wall, a first end wall located at a first end of the bottom wall, a second end wall located at a second end of the bottom wall; and at least one first end stop located on an inner surface of the first end wall; and at least one second end stop located on an inner surface of the second end wall, wherein the at least one first and the at least one second end stop are arranged to engage the microfluidic device plate and secure the microfluidic device in the frame to avoid lateral movement upon tilting.

The frame may advantageously comprise a hinge on at least one end of the frame for a pivoting movement, whereby the center of the hinge forms the pivoting axis around which the frame and/or plane plate can be tilted or inclined.

The frame further comprises a tilting element effecting the pivotal movement of the plate and/or frame.

In a preferred embodiment, the frame further comprises an electric motor drive unit as actuator mounted on the base member and having an eccentric output member of predetermined eccentricity rotatable at a predetermined speed; and means for coupling the eccentric output member to the frame for pivoting the frame at predetermined amplitude and frequency.

Displacement about the pivoting axis may be carried out when the device is stopped or during the course of movement; as set out above, displacement is provided for through angle α which extends from the first plane, to the second inclined plane of the microfluidic device. The same applies to angle β, as set out herein above, for the first and the third plane. The skilled person understands that when the microfluidic device is tilted over the second pivoting axis, a figure analogous to FIG. 4 can be depicted with (side views) of planes I and III and inclination angle β.

This angles α and β can be set at any suitable position, whereby values between approximately 0.1° to 65° being preferred, more preferably of from 1° to 50°, yet more preferably of from 5° to 45°.

The subject apparatus is preferably configured to hold the at least one microfluidic device. The apparatus accordingly advantageously comprises a platform or frame that is adapted and configured to have a microfluidic device placed onto the platform in a secure and repeatable manner. Preferably this may be achieved by shaping a platform such that it forms a frame that has dimensions and shape allowing the microfluidic device to be securely placed into the frame, such that there is no lateral motion possible. Preferably, this requires at least the presence of at least one end stop that prohibits the device from moving laterally during the tilting operation.

The apparatus is preferably configured to receive a preferably standard size microfluidic device comprising at least one microfluidic channel, such as a cell culturing device, and a mechanism that moves the device as described in further detail below. Advantageously, thus, the microfluidic device has an essentially elongate rectangular shape, preferably of the dimensions of a standard micro titer plate. Length L and width W refer to the major dimensions of the microfluidic device herein, whereby L refers to the longer of the two, and W to the shorter. In order to allow for scalability, the apparatus preferably is configured to accommodate a single microfluidic device, however several devices may be combined, as set out below

In modern laboratories it is currently common practice to use standardized micro titer plates as sample containers which comprise in a single plate a plurality of sample containers. By using such micro titer plates, a whole number of different samples or so-called libraries subjected to various tests simultaneously, especially for so-called high-throughput screening (HTS) methods in which the samples can be processed in an automated manner by robots for example.

This standardized architecture allows the use of so called plate hotels for incubation and experimentation, whereby typically several stacks of micro titer plates are located on carrousels, which can be operated and incubated fully automatically.

Accordingly, the device according to the invention is typically configured to accommodate a microfluidic device of micro titer plate dimensions, or a generally, a micro titer plate according to one or more of ANSI/SLAS 1-2004 (R2012) Microplates—Footprint Dimensions (formerly ANSI/SBS 1-2004), ANSI/SLAS 2-2004 (R2012) Microplates—Height Dimensions (formerly ANSI/SBS 2-2004), ANSI/SLAS 3-2004 (R2012) Microplates—Bottom Outside Flange Dimensions (formerly ANSI/SBS 3-2004) or ANSI/SLAS 4-2004 (R2012) Microplates—Well Positions (formerly ANSI/SBS 4-2004). The ANSI/SLAS standards govern various characteristics of a microplate, in particular plate properties, i.e. dimensions and rigidity, which allows interoperability between microplates, instrumentation and equipment from different suppliers, and is particularly important in laboratory automation. The dimensions of length versus width are referred to as the micro titre plate “footprint” herein.

The microfluidic device comprises at least one, but preferably a multiple of microfluidic channel networks. At least one such a network has reservoirs that coincide with the position of a well of a 6, 24, 48, 96, 384 or 1536 well plates or an integer multiple thereof. A typical example is given in PCT/NL2015/050416, wherein 96 microfluidic channel networks are present, each communicating with three reservoirs, the location of which coincide with wells of a 384 well plate. A fourth well is preferably used for optical interrogation of processes or events occurring in the microfluidic network. Preferably, therefore, the invention relates to a apparatus for microfluidic devices having a standard micro titer plate format.

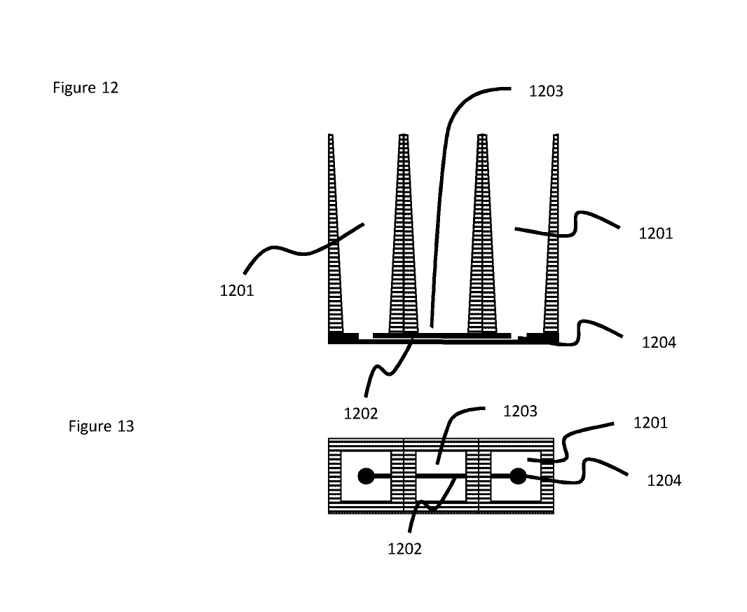

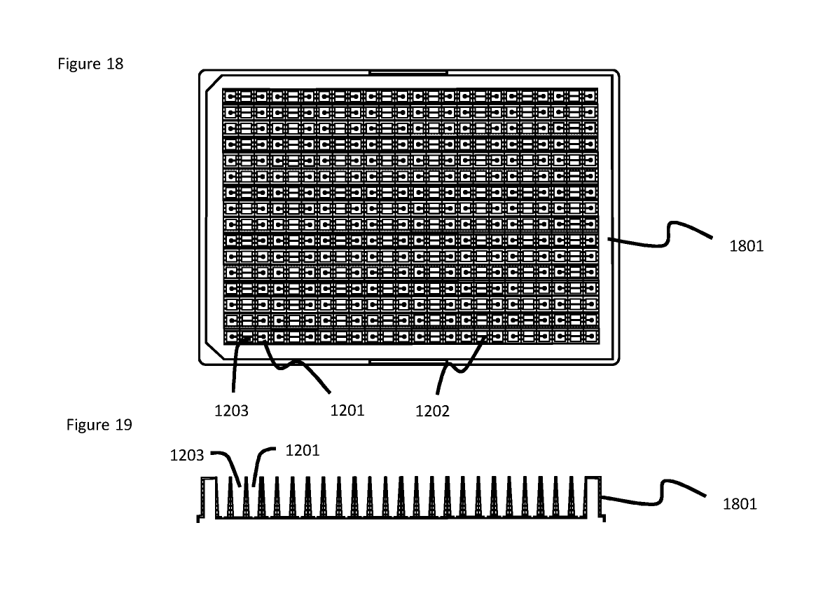

A further preferred microfluidic apparatus as illustrated in FIGS. 12 and 13, which show enlarged a subunit of the microtiter plate according to FIGS. 18 and 19. The plate may comprise a single microfluidic channel 1202 that has two reservoirs 1201 that may contain liquid. A third reservoir 1203 provides optical access to the microfluidic channel for interrogation. It should be noted that this is an example of a suitable microfluidic device; however the present device and methods are suitable for use with a wide variety of microfluidic devices, such as those disclosed in WO2014038943, WO2015019336, US-A-20140065597, EP-A-2683811 or EP-A-2683481.

In a further preferred embodiment according to the invention, the apparatus platform comprises a means for optical interrogation of the one or more microfluidic channels, including a microscope ocular, CMOS sensors, CCD camera, preferably any device suitable for the continual observation of a specimen.

Preferably, the base comprises a base plate configured and shaped for receiving the microfluidic device, as well as permitting to fulfill desired functions, e.g. having a free optical path for observation. Preferably, the base plate and/or hinged platform comprise a transparent pathway, for permitting the use of an imaging device for analyzing the microfluidic device. The optically transparent pathway may advantageously be provided by an aperture, or a separation comprising an optically transparent material, preferably a glass plate or otherwise transparent material. This may advantageously be provided in or on top of the base.

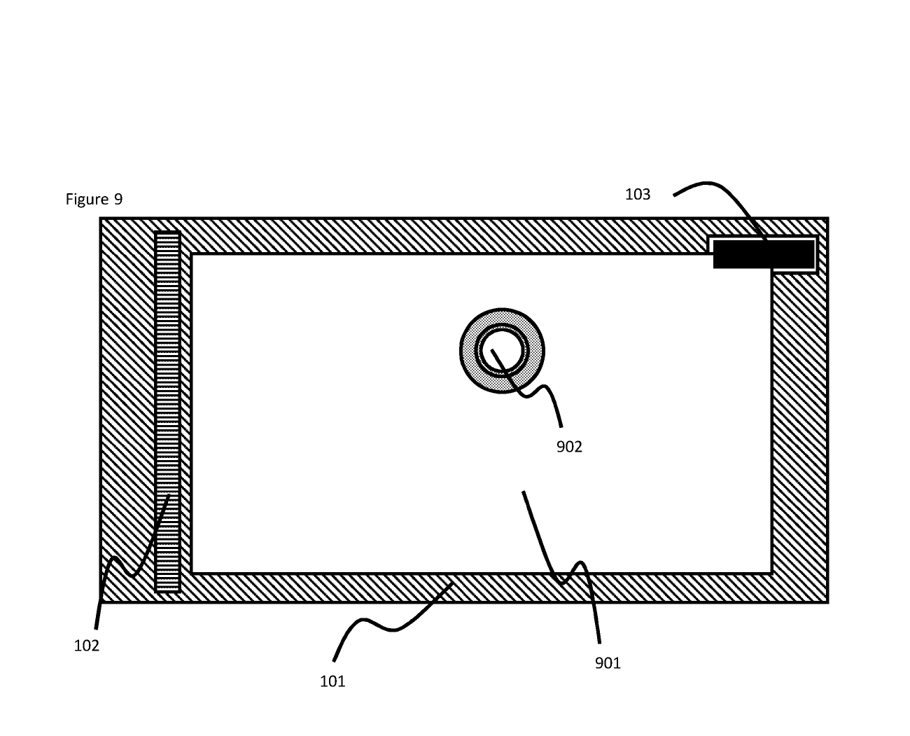

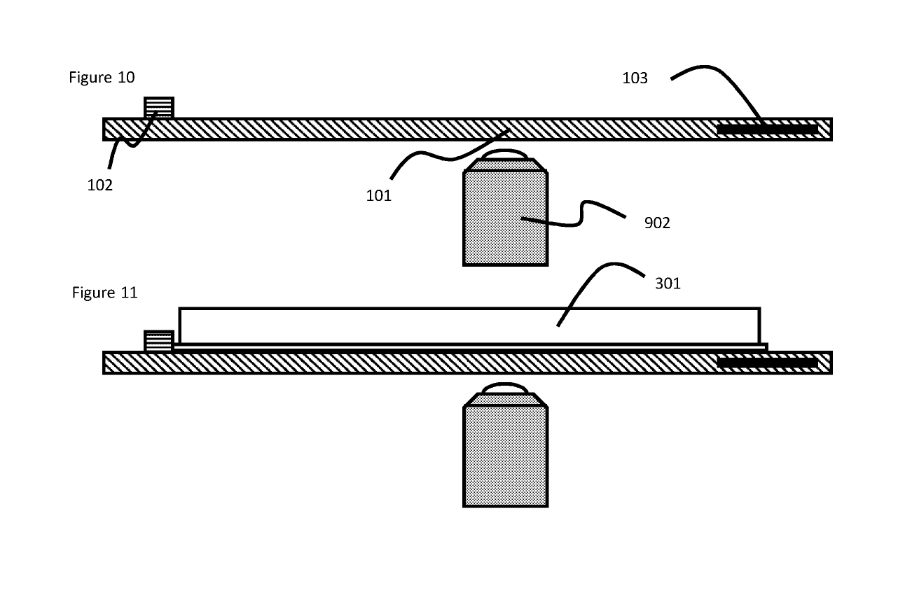

Preferably, the imaging device comprises a microscope, a plate reader and/or a high-content imager, and imaging setup for surface plasmon resonance and/or SERS. In FIGS. 9 to 11, a further preferred embodiment of the apparatus according to the invention comprises a frame 101 having an opening 901. The embodiment further comprises an ocular, positioned such that the microfluidic plate can be observed from the underside. The ocular is not necessarily part of a microscope, but may advantageously be any type of suitable sensor, including CMOS, CCD, or setups to detect surface plasmon resonance, SERS, and the like. The opening in the frame is not strictly necessary for all type of sensors.

An advantage of the present apparatus is the fact that the resting position of the microfluidic device may be employed as the position wherein the imaging device acquires data. This has the benefit that it permits optical or microscopic surveillance of the microfluidic channel. The base plate and the end-stop will assure precise repositioning of the microfluidic device to the same horizontal plane after each tilting move, which allows timed registration with automated means and without adjusting focus of lenses to be used.

By designing the movement appropriately, the lens may further be positioned in close proximity to the channel. By choosing the pivot point in essentially the same plane as the microfluidic network and at one end of the microfluidic apparatus, the movement during tilting is primarily upwards, such that the ocular can be positioned in the direct vicinity of the plate without the need to remove it when transitioning into a tilted state.

An advantageous use of the apparatus of invention is thus that flow induction can be combined with real-time microscopic observation. This allows for time-lapse recording over period of time, while still inducing flow in the device in a controlled manner. Moreover, absence or largely absence of downward translation during the tilting motion, means that the latter does not interfere with hardware that is positioned underneath the apparatus, such as a microscope ocular.

Advantageously, the resting position of the microfluidic device can be precisely determined by the base and the end-stop, such that after each translational motion, the microfluidic device is precisely repositioned for optical interrogation.

Preferably, the tilting element may also be configured to apply a lateral force such that the microfluidic device is pushed against the end-stop and precise repositioning is secured. Alternatively, an additional element can be introduced that pushes the microfluidic device against the end-stop during the translational motion and/or upon returning to the resting position wherein the microfluidic device rests in an essentially horizontal plane.

In a particularly preferred aspect, the device according to the invention is positioned on a microscope stage, allowing continuous monitoring of aspects occurring in the microfluidic channels and reservoirs. Preferably the microscope stage is an automated stage, allowing imaging of multiple microfluidic channels and reservoirs in a single experimental setting. More preferably, the microscope stage is an incubated microscope stage, allowing control over parameters such as CO₂ tension and humidity and in some cases also O₂ tension, whereby the oxygen or carbon dioxide tension refers to the partial pressure of oxygen or carbon dioxide molecules dissolved in a liquid.

In a preferred embodiment, the microfluidic device is shielded from an ocular or sensor at the bottom side or below the apparatus also in tilted state, such that the incubated stage does not communicate with the outside world, which may cause condensation or otherwise negatively impacts the conditions in the incubator and/or sensor environment.

In a preferred exemplary embodiment, the base comprises a glass plate or plate from otherwise transparent material providing optical access, but shielding the atmospheric conditions from above the base plate from those below the base plate.

The optically transparent pathway, preferably comprising a glass plate or otherwise transparent material in or on top of the base, any or all of the base, separation elements and tilting element is can be climate controlled, in particular, wherein temperature and/or humidity are controlled. This may have the advantage of controlling the formation of e.g. condensation which may negatively affect the optical transparency, and hence the acquisition of data.

In a second exemplary and preferred embodiment, the apparatus comprises one or more separation elements, such as flanges or a flexible conduits or side walls that shield the microfluidic device during tilting on its side and/or the tilting side. In that manner, the microfluidic device itself and the flanges shield the atmospheric conditions from above the microfluidic device from those below the microfluidic device. By using such separation elements, which do not impair the motion of the device, the atmosphere of the microfluidic device can be effectively encapsulated and separated from the atmosphere at which the optical sensor is located, thereby reducing e.g. the heat and humidity exchange, and also may reduce condensation that may impair the optical assessment of the process. Accordingly, the base may further advantageously comprise one or more separation elements that impede fluid communication of the space above the device to the space below the device. Preferably, the separation element comprises vertical flanges on top of the base, which are configured to guide the transition of the microfluidic device from the first position to the second position and vice versa. In general, these are preferably configured to engage with the base accommodating the microfluidic device such that the tilting motion of the device is not impaired, thereby preventing or at least partly preventing exchange or interaction of climate conditions in the space above the microfluidic device with those below the microfluidic device.

Preferably, the present apparatus comprises one or more separation elements configured to reducing communication of gaseous components between the space above and the space below the device.

Preferably, the apparatus according to the present invention is shaped such that they can be employed in a so called plate hotel, i.e. for instance a carrousel comprising a multitude of plateaus of microfluidic devices including multi-well assay plates, which are typically employed for robot automation and storage in automated incubation systems. In a preferred embodiment according to the invention multiple apparatuses are arranged in an orderly fashion one next to the other and/or above one another; each apparatus preferably comprising an end-stop and/or a hinged platform and a tilting element as set out above.

Each tilting element may advantageously be actuated by a single actuating element, but this not necessarily needs to be so. The actuation may be synchronous, whereby optionally the actuation of a multitude of devices is performed by a single actuator, either simultaneous or in sequence.

Preferably, the multiple apparatuses may be arranged in a carrousel or in a matrix fashion, such as typically used in plate hotels. The arrangement may advantageously be configured to permit placement in an incubator, for control of the environmental conditions. This preferred embodiment of subject invention is particularly suitable for handling of multiple microfluidic devices in an automated environment.

Ideally, the apparatus is structured such that it can be placed into an incubator while operating, for instance in the form of an instrument that has dimensions defined by the height of the microfluidic device plus the maximum end point of the microfluidic device or base of the apparatus when tilted.

In another advantageous embodiment of the invention, it may be in the form of a carrousel that can be placed in an incubator and used for robotic handling of the microfluidic devices. Accordingly, the present invention also pertains to an arrangement comprising a multitude of microfluidic devices. Preferably, the arrangement comprises a rack, comprising one or more plateaus configured to each comprise a multitude of microfluidic devices, or a matrix comprising a multitude of devices. Advantageously, the arrangement comprises an incubation system for adjusting and maintaining the environmental conditions in the space comprising the one or more apparatuses.

The present invention also pertains to a method for generating a flow in a microfluidic channel.

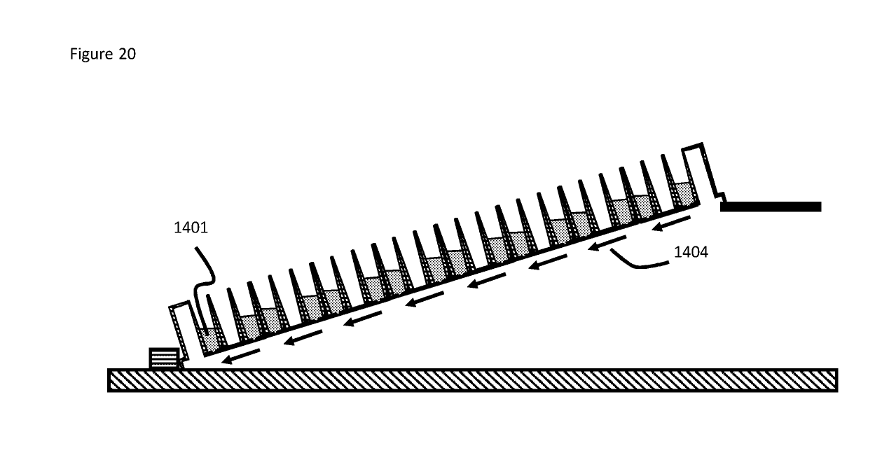

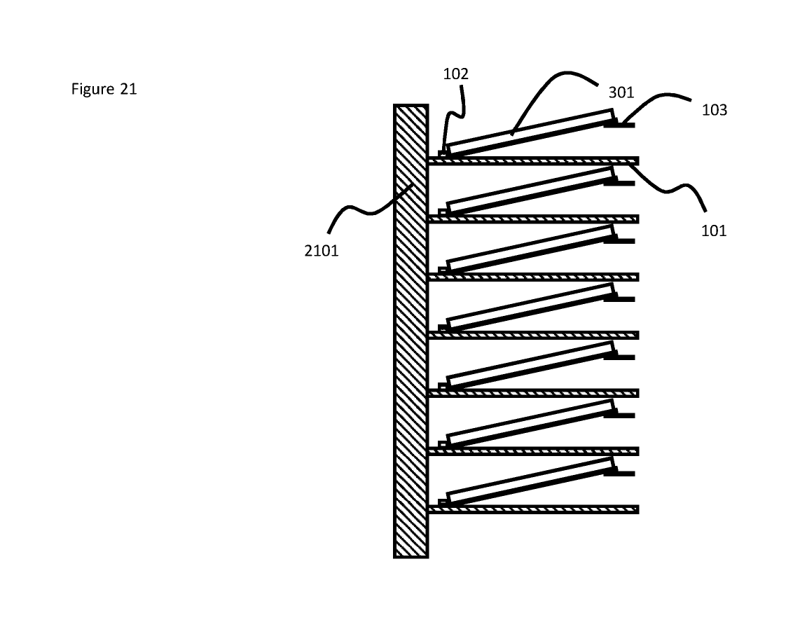

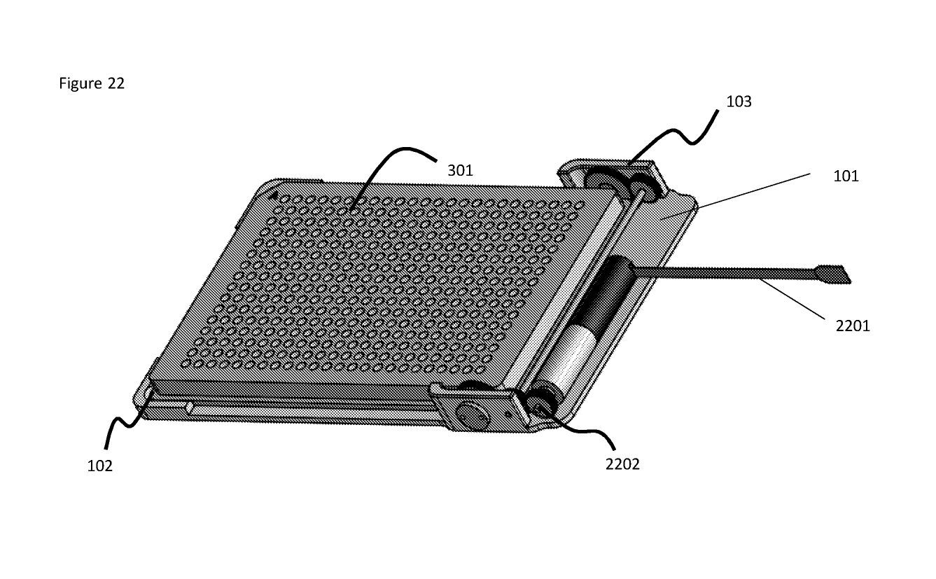

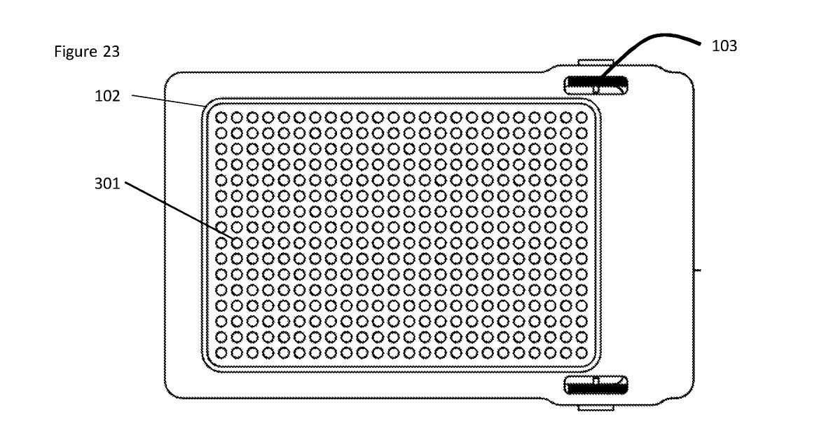

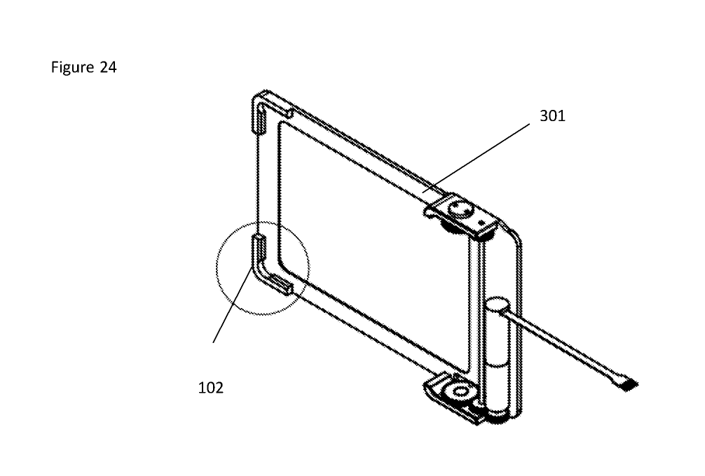

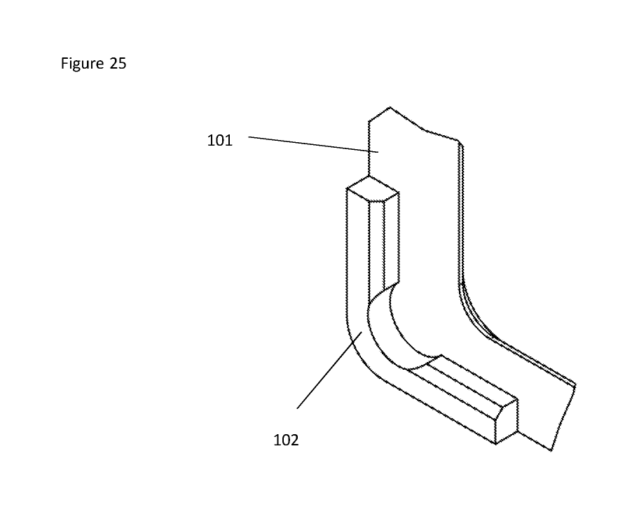

In a typical use of the apparatus and method of invention, cells are cultured in a microfluidic device and leveling of reservoirs generates a flow growth medium in the microfluidic channel. The induced flow assures provision of nutrients and oxygen to the cells as well as transports away otherwise noxious metabolites. A typically versatile use of the device of invention is sketched in FIG. 20, whereby the device is loaded with a microfluidic device in shape and dimensions of a microtiter plate, the device comprising multiple microfluidic channel networks that are all actuated/leveled in parallel.

In addition leveling of reservoirs may be used to maintain the concentration of a drug compound in the microfluidic channel, to provide a reporter molecule and maintain its concentration at a constant level throughout the experiment and/or provide staining reagents to the cells.

In a further preferred aspect, the present invention relates to a method for generating a gravity induced flow of a fluid medium in a microchannel present in a microfluidic device, comprising changing the angle of the first plane defined by the microchannel surface by rotation around a primary pivoting axis, whereby the axis is contained in the first plane.

This method preferably comprises the steps of: a. positioning the microfluidic device having at least one microchannel that connects two reservoirs; the reservoirs and the microfluidic channel is filled with a fluid comprising a fluid medium in the microfluidic channels in a resting position in a horizontal plane, preferably against an end stop; b. tilting the microfluidic device over a first pivoting axis by lifting at one end to induce a first fluid flow in the microfluidic channel; preferably c. preventing the device from movement in down-slope direction; and d. returning the microfluidic apparatus into the resting position, and thus against the end-stop, thereby inducing a second fluid flow in the microfluidic channel, and optionally, repeating steps b to d. Advantageously, the amplitude, duration and/or frequency of repeating steps a to c, and d to e may be varied.

Furthermore, advantageously, the method further comprises the steps of: d. lifting the microfluidic device at a second end, thereby tilting it over a second pivoting axis essentially perpendicular to the first pivoting axis, and e. returning the microfluidic device to the resting position

The present invention also relates to a method for growing and nurturing life based particles, such as biological cells in a microfluidic channel, comprising the method set out above, wherein the microfluidic device comprises cells. The present invention thus also relates to a method for the acquisition of real time data from a microfluidic device in a apparatus according to the invention, or in a plate hotel, comprising analyzing the microfluidic device at predetermined intervals. The moment of acquiring data advantageously may coincide with step c of the method.

More preferably, the present invention also relates to a method for the acquisition of real time data from a microfluidic device in a apparatus according to the invention, or an arrangement of the devices. The method preferably comprises subjecting the microfluidic device at predetermined intervals to an analysis, preferably by using an imaging device or sensor comprises a microscope, a plate reader, SPR imaging setup, SERS imaging setup and/or a high-content imager.

Preferably, this method also comprising the steps of: f. placing the life based particles, such as bacteria, fungi, yeasts, and cells, or tissue comprising life based particles to be cultured in the microfluidic device; and optionally g. culturing the life based particles or tissues, wherein the culturing step comprises flowing life based particles or tissue culture medium through the microfluidic device. Steps f, and optionally g, may advantageously be applied at the start of, or during the method. Steps f and/or g may comprise additional steps, such as pipetting of a gel, which are typically part of the protocols that are followed.

The present apparatus allows generating a flow of growth medium in a microfluidic cell culturing device comprising cell cultures in plate like structure by leveling between at least two reservoirs. In this manner, cells can be foreseen of necessary nurturing agents for their metabolism, while providing a flow of a medium, similar or approximately similar to the motion of blood through an organ in a live creature.

The method advantageously further comprising the step of performing an analysis or assay of an effect of an agent of interest on the cultured life based particles or tissue, thereby determining an in vitro effect of the agent of interest on the cultured life based particles or tissue.

Preferably, the method further comprises the step of encapsulating life based particles to be cultured in a gel or hydrogel or against a gel or hydrogel. This may often represent the first step of the subject process, whereby e.g. a flow of a medium comprising nutrients is effected once the gel has been put in place.

The method advantageously permits to asses, if the fluid contains a compound, reagent, chemical substance, virus, bead, or other cell type, the effect of these on the life based particles to be tested. Preferably, the fluid contains a compound for staining, assaying the life based particles or other reporter compounds, or particles for transducing signals

The present method is further advantageous over those using presently known laboratory rocker, in that the flow in microfluidic devices can be continuously maintained in the simplest manner possible, i.e. a two-state process: first and second position, such as highly preferred horizontal and inclined position. Presently known methods for maintaining flow by leveling using a standard laboratory rocker, are changing inclination angle in a continuous mode. Moreover, the type of rockers that are used are bulky, do not allow for real-time monitoring or time-lapsing under flow and are not compatible with plate hotels.

This provides the possibility to define and model fluid flow in e.g. organs. Alternatively used present methods also involve subjecting the entire plate hotel, or moving the carrousel to a motion, which makes it very cumbersome and overly complex.

The device according to the invention, while of advantageously simple construction, can be used in a large number of ways. It will be obvious to those skilled in the art that many modifications may be made within the scope of the present invention without departing from the spirit thereof, and the invention includes all such modifications.

### Example

An apparatus according to the invention comprising a microfluidic device as set out below was placed inside an incubator, further comprising a microscope stage. The following experiment was done:

The apparatus is loaded with a microfluidic device as disclosed in FIG. 18 comprising 96 microfluidic networks that are partially loaded with a gel. A tubular tissue, i.e. comprising cells forming an endothelial vessel or proximal tubulus was grown in the perfusion channel.

Each tubulus was incubated under continuous flow conditions as described by the method of invention, enabling perfusing the tubuli through its luminal side primarily.

In an ideal case, this protocol may result in 96 tubuli that can be interrogated for leak tightness and the effect of a compound on the barrier integrity of the tube.

The device on a apparatus was analyzed visually using the incubated microscope stage. The medium reservoirs were loaded with a reporting dye, such as FITC-dextran, FITC-inulin, Lucifer Yellow or other fluorescent compound. Selected reservoirs were then loaded with a compound of choice in a combination of choice. The loading of reservoirs was performed before placing the device on the tilting apparatus; however, in practice this may be done at any stage during the process. Once loaded and placed into position, the incubator chamber was closed and the tilting sequence was started. The tilting apparatus changed between the two states (horizontal and inclined) every 10 minutes, and each time the microfluidic device returned to its first, horizontal base position, an image was recorded. The amount of fluorescence in the gel channel at that time point was used as an indication of the leakiness of the tube, and whether the presence of the added compound might have had an effect thereon. The tilting and imaging sequence was extended over several hours in order to monitor effect of a compound over extended time periods.

It was found that under the flow conditions, using the present apparatus, tubuli could be grown and maintained operable for several days. The flow was found crucial for the health state of the tubulus, which was found to disintegrate once the flow stops.

It is noted that this prolonged maintenance of suitable growth conditions may be of particular interest when evaluation low concentrations of e.g. a toxic compound, or a compound of low toxicity/efficacy, which may need extended exposure periods to show an effect. Also, a clear advantage of the use of the apparatus according to invention was that flow was maintained while at the same time imaging could take place, allowing a control and almost continuous analysis of the process over time, without the need to interrupt the incubation for an off-line analysis.

1. An apparatus for inducing flow of a fluid in a microfluidic device that comprises at least one microfluidic channel, the apparatus comprising:
a. a base, on which said microfluidic device is pivotally disposed, defining a first position in a first plane (I); and
b. a selectively operable tilting element attached to said base, to pivot the microfluidic device with respect to the base, thereby inducing fluid flow through the at least one microfluidic channel;
wherein the base accommodates the microfluidic device in a first position defining a first plane, wherein the tilting element pivots the microfluidic device from the first position to a second position defining a second plane (II), and wherein the microfluidic device is tilted about a pivoting axis bisecting the first plane, thereby defining an inclination angle α between the first plane and second plane.

2. The apparatus according to claim 1, wherein the pivoting axis is located opposite a lifting point with respect to the microfluidic device's centre of gravity, wherein the lifting point is the point at which the tilting element applies pressure to the microfluidic device in order to lift said microfluidic device.

3. The apparatus according to claim 1, wherein the pivoting axis is spaced from the lifting point at which the tilting element is lifting the microfluidic device by a distance of at least half of length L of the major axis of the microfluidic device, or the width W of the microfluidic device if the pivoting axis of the device is positioned orthogonally to the major axis of the microfluidic device.

4. The apparatus of claim 1, wherein the base further comprises an end stop limiting lateral or downward shifting motion of the microfluidic device.

5. The apparatus according to claim 4, wherein the end stop is co-located with the pivoting axis, and wherein the lifting point is located opposite to the end stop, with respect of the microfluidic device's center of gravity.

6. The apparatus according to claim 1, further comprising any one or more of:
a frame configured to securely accommodate the microfluidic device, wherein the frame is connected to the base by a pivotally operable hinge;
a further tilting element for tilting the microfluidic device over a second pivoting axis from the first position in a first plane to a third position in a third plane at an inclination angle β to the first plane.

7. (canceled)

8. The apparatus according to claim 6, wherein the first and second pivoting axes are spaced away from the respective first and second tilting element and/or lifting points by a distance of more than half the length L, and/or width W of the microfluidic device, respectively.

9. The apparatus according to claim 1, wherein the first plane is an essentially horizontal plane.

10. The apparatus according to claim 9, wherein the shape and dimensions of the microfluidic device coincide with the footprint of a standard micro titer plate, and the base is configured to accommodate said standard micro titer plate, wherein the footprint is defined by micro titer plate standard ANSI/SLAS 1-2004 (R2012).

11. The apparatus according to claim 4, wherein the tilting element exerts a force on the microfluidic device that has a lateral component in the direction of the end stop, whereby the force is exerted continuously, or only during transition from the second position to the first position.

12. The apparatus according to claim 1, further comprising a sensor to measure the state and position of the tilting element or an actuator driving the tilting element, or both.

13. The apparatus according to claim 1, wherein the base is provided with an optically transparent part defining an optically transparent path.

14. The apparatus according to claim 13, wherein the optically transparent path is provided by any one or more of: an aperture or a separation comprising an optically transparent material, a separation which comprises a glass or transparent plastic plate provided in or on top of the base.

15. (canceled)

16. The apparatus according to claim 13, wherein the optically transparent path is climate controllable.

17. The apparatus according to claim 1, comprising vertical flanges on top of the base configured to guide the transition of the microfluidic device from the first position to the second position and vice versa, such that the tilting motion of the microfluidic device is not impaired, thereby essentially preventing exchange or interaction of climate conditions in the space above the microfluidic device with those below the microfluidic device.

18. The apparatus according to claim 1, further comprising an imaging device, microscope objective, sensing device or sensor.

19. The apparatus of claim 1 in an arrangement comprising a multitude of apparatuses according to any of claims 1 to 18, or in a matrix of apparatus of any of claims 1 to 18, wherein the arrangement or matrix comprises one or more plateaus configured to each apparatus.

20. A method for inducing a flow in a microfluidic device comprising one or more microfluidic channel(s) connected to at least a first and a second reservoir, comprising the steps of
a. positioning the microfluidic device comprising a fluid medium in the one or more microfluidic channel(s) or reservoirs, or both, in a first position in a first horizontal, plane (I) on a base;
b. tilting the microfluidic device from the first position to a second position in a second plane (II) about a pivoting axis bisecting the first and the second plane, to an inclination angle α between the first plane and the second plane to induce a first fluid flow in the one or more microfluidic channel(s); and
c. returning the microfluidic apparatus into the first position, thereby inducing a second fluid flow in the one or more microfluidic channel(s), wherein steps (b) and (c) are performed essentially in absence of lateral shifting movements of the microfluidic device.

21. The method according to claim 20, wherein the microfluidic device is positioned on the base of an apparatus according to any of the claims 1 to 18.

22. The method according to claim 20, wherein the microfluidic device is tilted by lifting at a first lifting point located at the opposite side of the centre of gravity of the microfluidic device with respect to the pivot axis.

23. The method according to claim 20, further comprising
d. tilting the microfluidic device over a second pivoting axis to a third position in a third plane, and
e. returning the microfluidic device to the first position.

24. The method according to claim 23, wherein the first and second pivoting axis bisect the first plane.

25. The method according to claim 23, wherein steps a to c or a to e, or both, are repeated, and wherein any one of the angles, duration, interval or order of a to e may be varied.

26. A method for the acquisition of real time data from a microfluidic device in an apparatus according to claim 1 comprising acquiring data from the microfluidic device at predetermined intervals, by using any one of: an imaging device or sensor comprising a microscope, a plate reader, SPR imaging setup, SERS imaging setup or a high-content imager.

27. The method for the acquisition of real time data according to claim 26, wherein the imaging device acquires data in the first position of the microfluidic device.
